(19) United States
(12) Patent Application Publication
(10) Pub. No.: US 2012/0261048 A1
(43) Pub. Date: Oct. 18, 2012

(54) Vinyl graphics installation

(76) Inventor: Jason Carolla, Vaudreuil (CA)

(21) Appl. No.: 13/066,570

(22) Filed: Apr. 18, 2011

(51) Int. Cl. B32B 7/12; B44C 3/12

(52) U.S. Cl. 156/63; 428/211.1

(57) ABSTRACT

An apparatus and method in accordance with the principles of the present invention decreases the time required to install the vinyl graphics while maintaining the accuracy of the installation. In accordance with the principles of the present invention, a pressure sensitive tape is provided. The pressure sensitive tape includes a thin, easy-to-tear substrate, an easily released pressure sensitive adhesive that allows the tape to be easily removed without leaving residue or damaging the surface to which it is applied, and a plurality of non-adhesive tabs contained on the tape. The non-adhesive tabs contained in equally spaced intervals on the tape. The tape is used in securing the vinyl graphic by taping the vinyl graphic to the surface utilizing two hinged pieces of tape; the non-adhesive tabs contained in equally spaced intervals on the tape are used to help ensure the vinyl graphic is applied even or level.

### FIELD OF THE INVENTION

The present invention relates to vinyl graphics.

### BACKGROUND OF THE INVENTION

Vinyl graphics appear on a large variety of subjects, such as for example vehicles, banners, machinery, store displays, and the like. Advances in chemistry, evolving manufacturing methods, societal demands, and changing business conditions mark the history and evolution of vinyl graphics. Vinyl can be cut by computer controlled processes, producing lettering and graphics with no background, or it can be printed onto solid sheets, producing vehicle and equipment wraps. Both vinyl graphic types are installed in very similar manners, both of which take copious amounts of careful planning and preparation. With vinyl graphics, the signage and graphics-arts industries have been transformed, and businesses have gained a bright, modem way to advertise and identify themselves.

In 1937 3M engineers laid double-coated cloth tape, which contained glass beads, as a roadway median. Although this early reflective product was significantly brighter than white paint, adhesive failure resulted in the strips stripping away from the road surface. This experience led the development team to change course and focus on reflective sheeting for road signs. By the late summer of 1939, the first highway signs covered with reflective sheeting appeared on a Minnesota highway, and a new era in signage began. Aggressive adhesives developed for reflective sheeting's backside helped it adhere to metals, wood, and other surfaces. Vinyl coatings that protect the top surface eventually led to the development of non-reflective, marking films. This was the first vinyl-film variety used for truck decoration and identification.

In the 1940s, a process to cast film on a liner was invented. With some refinements, this technology is still in use today. Film cast on a release liner, which does not get stretched, yields an inherently thin, strong film that will not shrink. Cast film produces high-quality graphic film with excellent uniform color, although calendering and extrusion technologies have improved enough that such films are useful for many applications. In 1953, non-reflective lettering, using a solvent or heat-activated adhesive, was introduced. The coating technique produced approximately 20 feet of film per minute, but early technicians were lucky to achieve a 50% yield. Vying for market acceptance versus hand-painted graphics, early vinyl materials offered greater durability, as well as the ability to be die-cut in mass quantities. An initial order for this film entailed decorating World War II military planes with the Air Force logo.

In 1956, pressure-sensitive vinyl film hit the market. This advancement, combined with more color introductions, enabled greater vinyl usage to fabricate attractive signs and emblems. Two years later, an easy-to-peel, silicone-release liner was developed to protect the adhesive backing of the vinyl film. That same year, a new fluorescent film, used for enhanced hospital and school-sign visibility, was introduced.

In 1958, the graphics industry enjoyed more color choices, such as a gold display film, which was used initially to create metallic stripes on Eastern Airlines planes and beer trucks. In 1960, a display film designed for such short-term signs as store windows became available. Over the next few years, product innovations and introductions continued. Advancements included films for window stickers, vandal-resistant markings, and embossed, textured and metallic films. Film colors also expanded well beyond such early colors as white, black, red, blue, and yellow. Vehicle-graphic designers, who wanted films to match the dazzling colors of cars streaming out of Detroit assembly lines, spurred many of these developments. During the early 1960s, the market for decorative films—particularly wood-grain replicas—surged. To make these films realistic, technicians etched wood-grain features from real wood veneers onto the print rolls. By 1966, Chrysler, Ford, and General Motors all used wood-grain films on various models.

In 1982, Gerber Scientific introduced the first vinyl cutter. This vinyl cutter began a revolution in the sign making industry and changed the way that signs are made. This Signmaker® was easy to use and increased the productivity of many sign shops. In addition, many franchises developed as a result of this development because a layman could be trained to type in text, cut lettering, and make signs.

In 1983, translucent films, which overcame many technical challenges, were introduced. For the first time, technicians could cast 2-mil, wide-format films with uniform backlit color. Thus, a completely uniform image could be produced on translucent film when imaging a backlit substrate. Previous technologies, such as spray painting and screen printing, rarely produced uniform color densities.

In the late 1980's other systems were developed to compete with the Signmaker®. These systems were based on using a personal computer, software, and a pen plotter that was converted with a vinyl cutting attachment. These vinyl cutters were made by Houston Instruments and Ioline and, although they were neither as reliable as the Signmaker® nor did they track the vinyl as well, customers were able to overcome the problems with training and patience. These systems were priced thousands of dollars less than the Signmaker®, and the software contained more features and many fonts. In addition the systems could produce graphics.

In 1991, the first successful, large-scale, outdoor-durable, digital-printing process was unveiled—the electrostatic printer. This technology uses a process similar to photocopying by apply liquid toners to film. Using screen printed graphics, service providers had to wrap 100 trucks to make it economical, but this advance made it possible to profitably wrap single vehicles.

In 1996, an innovative film was introduced which contained micro-replicated air channels that allowed trapped air to escape. This meant applicators could install graphics while no longer needing to pop air bubbles with needles and knives. This air-egress technology set the standard for the next vehicle-graphics generation.

Electrostatic printers, which still produce up to 2,600 square feet of graphics per hour at 600 dpi, are being displaced by a slower, direct-printing process that provides better resolution. In 2000, piezo-inkjet printers hit the market using pigmented inks to provide a durable graphic with excellent color retention. Also, introduction of digital, electronic, vinyl-film cutters further revolutionized the sign industry. These cutters triggered significant production boosts and allowed faster, cheaper production. Also, these cutters increased the vinyl demand. Advancements in speed, size and detail capabilities soon followed and increased their industry impact.

In 2007, the latest generation of films with micro-replicated air channels offered more channels on a smaller scale, which ensured the surface of the micro-structured adhesive eliminated imperfections. This film developed from expertise gained from the development of micro-replication technology for traffic-control films.

Once created, care must be taken to properly install the vinyl graphics. A clean application surface is essential for a quality vinyl graphic application. The application surface must be thoroughly cleaned with a suitable soap-and-water solution and completely dried with lint-free towels. Any surface imperfection, including grit, dents or bubbles, must be repaired to avoid showing through the graphic. The application of a tack rag or roller immediately prior to installation helps care of minute particles.

The application area is measured carefully, and guide marks are created with for example a grease pencil. The vinyl graphic taped to the application surface and aligned to ensure the vinyl graphic is applied even or level. Thus, two strips of masking tape are placed across the top edge, forming a hinge. Once the vinyl graphic is in the proper position, a third piece of tape is applied that extends across the length (or width) of the vinyl graphic. The two hinged pieces of tape are then removed. This process is referred to as “hinging”.

The graphic consists of three separate pieces: a transfer tape, the vinyl graphic itself, and a backing. The transfer tape is pulled back and the backing sheet is slowly removed from the side (or top) section of the vinyl graphic and the transfer tape and vinyl graphic are applied to the application surface. After the backing is removed, the remaining piece of masking tape is removed and the vinyl graphic and transfer tape remain applied to the application surface. The transfer tape is removed and the vinyl graphic remains on the application surface.

Thus, it can be appreciated that installing vinyl graphics is a slow, painstaking process. While even the installation of a single vinyl graphic on for example a single truck will occupy a good deal of time, it is not unusual for multiple installations to be required, for example on an entire fleet of trucks. What therefore would be helpful in installing vinyl graphics would be an apparatus and method that decreases the time required to install the vinyl graphics while maintaining the accuracy of the installation.

### SUMMARY OF THE INVENTION

An apparatus and method in accordance with the principles of the present invention decreases the time required to install the vinyl graphics while maintaining the accuracy of the installation. In accordance with the principles of the present invention, a pressure sensitive tape is provided. The pressure sensitive tape includes a thin, easy-to-tear substrate, an easily released pressure sensitive adhesive that allows the tape to be easily removed without leaving residue or damaging the surface to which it is applied, and a plurality of non-adhesive tabs contained on the tape. The non-adhesive tabs contained in equally spaced intervals on the tape. The tape is used in securing the vinyl graphic by taping the vinyl graphic to the surface utilizing two hinged pieces of tape; the non-adhesive tabs contained in equally spaced intervals on the tape are used to help ensure the vinyl graphic is applied even or level.

### BRIEF DESCRIPTION OF THE DRAWINGS

FIG. 1 shows a perspective view of an example truck having a plurality of vinyl graphics applied thereon.

FIG. 2 shows a perspective view of an apparatus in accordance with the principles of the present invention for decreases the time required to install the vinyl graphics while maintaining the accuracy of the installation.

FIG. 3 shows a side-elevation view of a method utilizing the apparatus of FIG. 2 in accordance with the principles of the present invention for decreasing the time required to install the vinyl graphics while maintaining the accuracy of the installation.

### DETAILED DESCRIPTION OF THE INVENTION

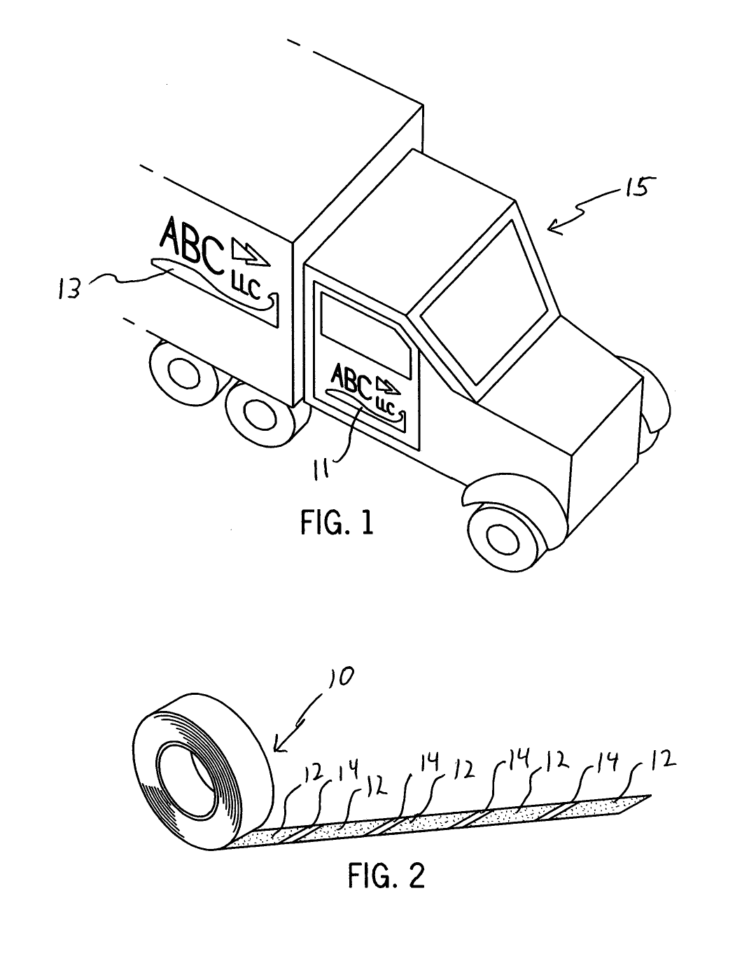

As previously detailed, installing vinyl graphics is a slow, painstaking process. While even the installation of a single vinyl graphic on for example a single truck will occupy a good deal of time, it is not unusual for multiple installations to be required, for example on an entire fleet of trucks. Thus, the installation of for example multiple vinyl graphics 11, 13 such as seen in the truck 15 depicted in FIG. 1 on an entire fleet of trucks would require a large dedication of time. In accordance with the principles of the present invention, an apparatus and method decreases the time required to install the vinyl graphics while maintaining the accuracy of the installation.

Referring to FIG. 2, a perspective view is seen of an apparatus in accordance with the principles of the present invention for decreases the time required to install the vinyl graphics while maintaining the accuracy of the installation. The apparatus comprises a roll of pressure sensitive tape 10 made of a thin, easy-to-tear substrate that is used in the installation of vinyl graphics. In one embodiment, the thin, easy-to-tear tape 10 can utilize as a substrate paper. The tape 10 further comprises an easily released pressure sensitive adhesive 12. The adhesive 12 allows the tape 10 to be easily removed without leaving residue or damaging the surface to which it is applied.

The tape 10 further comprises a plurality of non-adhesive tabs 14 contained thereon. The non-adhesive tabs 14 are contained throughout the roll of tape 10. The non-adhesive tabs 14 are contained in equally spaced intervals throughout the roll of tape 10. The width of the tape 10 and the actual spacing of the non-adhesive tabs 14 can vary, depending on the intended use of the tape. In one example embodiment, the width of the tape can be approximately 1 inch and the spacing of the non-adhesive tabs can be approximately 2 inches.

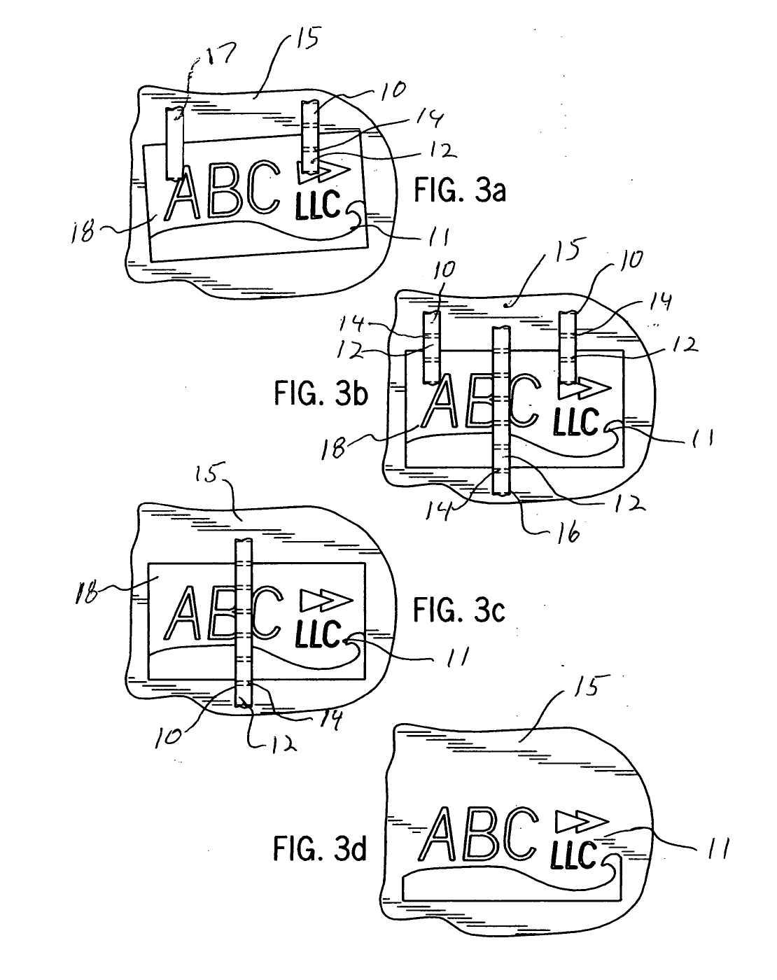

Referring now to FIG. 3, a side-elevation view of a method in accordance with the principles of the present invention for using the thin, easy-to-tear tape 10 in the installation of vinyl graphics is described. The vinyl graphic 11 is applied to a thoroughly cleaned and completely dried surface, such as in the example of FIG. 1 a truck 15. The vinyl graphic 11 is taped to the application surface and aligned to ensure the vinyl graphic is applied even or level. As seen in FIG. 3a, two strips of tape are placed across the top edge of the vinyl graphic 11, forming a hinge. As further seen in FIG. 3a, in this example one of the strips of tape is a prior art masking tape 17 while the second strip of tape is a thin, easy-to-tear tape 10 in accordance with the principals of the present invention. The drawback with using the prior art masking tape 17 is that when is applied with respect to the guide marks, it is very difficult to ensure that the distance at which each of the two strips of masking tape 17 secures the vinyl graphic 11 from the guide marks is equal, resulting in a non-even or crooked orientation of the vinyl graphic 11. Thus, time and care must be taken to ensure that the vinyl graphic 11 is properly positioned. Again, when installing multiple vinyl graphics on for example an entire fleet of trucks results in a large amount of time spent measuring and reorienting the hinged vinyl graphic 11 to ensure that the vinyl graphic 11 is properly applied even or level.

Referring to FIG. 3b, utilizing thin, easy-to-tear tapes 10 in accordance with the principals of the present invention as the two strips of tape placed across the top edge of the vinyl graphic 11 helps result in an even or level installation in less time. This is because the installer can utilize the plurality of non-adhesive tabs 14 contained throughout the roll of tape 10 as a measuring marker to ensure that the distance at which each of the two strips of tape 10 secure the vinyl graphic 11 from the guide marks is equal, resulting in a proper orientation of the vinyl graphic 11.

Once the vinyl graphic 11 is in the proper position, a third piece of tape 16 is applied that extends across the length (or width) of the vinyl graphic. This third piece of tape 16 can either be a prior art tape or, so that the installer does not need to carry two separate rolls, can be a thin, easy-to-tear tape 10 in accordance with the principals of the present invention.

As seen in FIG. 3c, once the third piece of tape 16 is applied that extends across the length (or width) of the vinyl graphic 11, the two hinged pieces of tape 10 are then removed. The transfer tape 18 is pulled back and the backing sheet (not seen as hidden behind the transfer tape 18 and vinyl graphic 11) is slowly removed from the side (or top) section of the vinyl graphic 11 and the transfer tape 18 and vinyl graphic 11 are applied to the application surface. After the backing is removed, the remaining piece of tape 16 is removed and the vinyl graphic 11 and transfer tape 18 remain applied to the application surface. The transfer tape is removed and the vinyl graphic 11 remains on the application surface, as seen in FIG. 3d.

While the invention has been described with specific embodiments, other alternatives, modifications and variations will be apparent to those skilled in the art. Accordingly, it will be intended to include such alternatives, modifications and variations within the spirit and scope of the appended claims.

What is claimed is:

1. A pressure sensitive tape comprising:
a thin, easy-to-tear substrate;
an easily released pressure sensitive adhesive that allows the tape to be easily removed without leaving residue or damaging the surface to which it is applied;
a plurality of non-adhesive tabs contained on the roll of tape, the non-adhesive tabs contained in equally spaced intervals on the roll of tape.

2. The pressure sensitive tape of claim 1 further wherein the substrate comprises paper.

3. The pressure sensitive tape of claim 1 further wherein the width of the tape is approximately 1 inch.

4. The pressure sensitive tape of claim 1 further wherein the spacing of the non-adhesive tabs is approximately 2 inches.

5. A method of installing vinyl graphics having a transfer tape, a vinyl marking, and a backing sheet on an application surface, comprising:
measuring the location for placement of the vinyl graphic;
securing the vinyl graphic by taping the vinyl graphic to the surface utilizing two hinged pieces of tape comprising thin, easy-to-tear substrates having an easily released, pressure-sensitive adhesive that allows the tape to be easily removed from the surface without leaving residue or damaging the surface to which it is applied, the tape further comprising a plurality of non-adhesive tabs contained in equally spaced intervals on the tape;
utilizing the non-adhesive tabs contained in equally spaced intervals on the tape to align the vinyl graphic;
applying a third piece of tape that extends across the vinyl graphic;
once the third piece of tape is applied, removing the two hinged pieces of tape;
pulling back the transfer tape and removing the backing sheet, thereby applying the transfer tape and vinyl graphic to the application surface;
after the backing is removed, removing the remaining piece of tape; and
removing the transfer tape, leaving the vinyl marking on the application surface.

6. The method of installing vinyl graphics of claim 5 further comprising applying as the third piece of tape a securing a thin, easy-to-tear substrates having an easily released, pressure-sensitive adhesive that allows the tape to be easily removed from the surface without leaving residue or damaging the surface to which it is applied, the tape further comprising a plurality of non-adhesive tabs contained in equally spaced intervals on the tape.

7. The method of installing vinyl graphics of claim 5 further comprising applying as the third piece of tape a securing a thin, easy-to-tear substrates having an easily released, pressure-sensitive adhesive that allows the tape to be easily removed.
